(19) United States
(12) Patent Application Publication
(10) Pub. No.: US 2008/0024471 A1
(43) Pub. Date: Jan. 31, 2008

(54) DRIVING APPARATUS FOR DISPLAY DEVICE AND DISPLAY DEVICE INCLUDING THE SAME

(75) Inventors: Joon-Ha PARK, Busanjin-gu (KR); Il-Gon KIM, Seoul (KR); Tae-Hyeong PARK, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/768,634

(22) Filed: Jun. 26, 2007

(30) Foreign Application Priority Data
Jul. 27, 2006 (KR) 10-2006-0070689

(51) Int. Cl. G09G 5/00

(52) U.S. Cl. 345/204; 345/55

(57) ABSTRACT

A driving apparatus for a display device and a display device including the same include a plurality of pixels, each comprising a switching element, gate lines and data lines connected to the pixels. The driving apparatus includes: a gate driver which generates a gate signal and applies the gate signal to the gate line; a data driver which generates a data signal and applies the data signal to the data line; a transmission gate connected to each of the data lines; a signal controller which controls the gate driver and the data driver; and a control signal generator which generates a plurality of control signals based on a scanning start signal and a plurality of clock signals and applies the control signals to the gate driver and the transmission gate. As the control signal generator generates a plurality of control signals, the number of test pads can be reduced when a VI test is performed, and furthermore a manufacturing cost can be reduced by reducing the number of pins of a driving chip.

This application claims priority to Korean Patent Application No. 10-2006-0070689, filed on Jul. 27, 2006, an all the benefits accruing therefrom under 35 U.S.C. §119, the contents of which in its entirety are herein incorporated by reference.

### BACKGROUND OF THE INVENTION

(a) Field of the Invention

The present invention relates to a driving apparatus for a display device and a display device including the same.

(b) Description of the Related Art

Recently, instead of heavy and large cathode ray tubes (“CRTs”), flat panel displays such as an organic light emitting diode (“OLED”) display, a plasma display panel (“PDP”) and a liquid crystal display (“LCD”) have been actively developed.

The PDP is a device for displaying a character or an image using plasma generated by a gas discharge, and the OLED displays a character or an image using electric field emission of specific organic materials or polymers. The LCD applies an electric field to a liquid crystal layer between two display panels and adjusts transmittance of light passing through the liquid crystal layer by adjusting an intensity of the electric field, thereby obtaining a desired image.

In a process of manufacturing a display device, a disconnection or short circuit of a display signal line or a defect of a pixel is ascertained through predetermined tests. The tests include an array test, a visual inspection (“VI”) test, a gross test, a module test, and so on.

In a system-on-glass (“SOG”) type display device in which almost all circuits are mounted in the display panel, it is not easy to apply a test signal due to the complexity of a driving signal. Because all signals for operating a driving circuit should be applied externally, several test pads for applying the test signal are required. Particularly, when data are transferred from a data driver to a data line using a transmission gate, the number of a test pads increases in proportion to an increase in the number of transmission gates. For this reason, an area for disposing the test pads increases and provides an inflow path for static electricity.

### BRIEF SUMMARY OF THE INVENTION

The present invention has been made in an effort to provide a driving apparatus for a display device and a display device including the same having a feature, aspect and advantage of reducing the number of test pads.

An exemplary embodiment of the present invention provides a driving apparatus for a display device including a plurality of pixels, each including a switching element, gate lines and data lines connected to the pixels. The driving apparatus includes: a gate driver which generates a gate signal and applies the gate signal to the gate lines; a data driver which generates a data signal and applies the data signal to the data lines; a transmission gate connected to each of the data lines; a signal controller which controls the gate driver and the data driver; and a control signal generator which generates a plurality of control signals based on a scanning start signal and a plurality of clock signals and applies the control signals to the gate driver and the transmission gate.

The control signals may include an output enable signal which adjusts a width of a high segment of the gate signal and a switching signal which controls an operation of the transmission gate.

The control signal generator may include a plurality of stages connected to each other and arranged in a line, and a logic unit connected to an output of at least two different stages.

Each stage may include a first tri-state buffer, an inverter connected to the first tri-state buffer, and a second tri-state buffer with an input and output are connected to an input and output of the inverter, respectively.

Each logic unit may be substantially an AND circuit.

The control signal generator may be integrated in the display device, and the switching element may be made of low temperature polysilicon.

Another exemplary embodiment of the present invention provides a driving apparatus for a display device including: a plurality of pixels, each including a switching element; gate lines and data lines connected to the pixels; a gate driver which generates a gate signal and that applies the gate signal to the gate lines; a data driver which generates a data signal and that applies the data signal to the data lines; a transmission gate connected to each of the data lines; a signal controller which controls the gate driver and the data driver; and a control signal generator which generates a plurality of control signals based on a scanning start signal and a plurality of clock signals and applies the control signals to the gate driver and the transmission gate.

The control signals may include an output enable signal which adjusts a width of a high segment of the gate signal, and a switching signal which controls an operation of the transmission gate.

The control signal generator may include a plurality of stages connected to each other and arranged in a line, and a logic unit connected to an output of at least two different stages.

Each stage may include a first tri-state buffer, an inverter connected to the first tri-state buffer, and a second tri-state buffer with an input and output connected to an input and output of the inverter, respectively.

Each logic unit may be substantially an AND circuit.

The control signal generator may be integrated in the display device, and the switching element may be made of low temperature polysilicon.

### BRIEF DESCRIPTION OF THE DRAWINGS

The accompanying drawings briefly described below illustrate exemplary embodiments of the present invention and, together with the description, serve to explain the principles of the present invention, in which:

FIG. 1 is a schematic view of a liquid crystal display according to an exemplary embodiment of the present invention;

FIG. 2A is a block diagram of a liquid crystal display according to an exemplary embodiment of the present invention;

FIG. 2B is a diagram illustrating a transmission gate shown in FIG. 2A in more detail.

FIG. 3 is an equivalent circuit diagram of one pixel of a liquid crystal display according to an exemplary embodiment of the present invention;

FIG. 4 is a block diagram of a control signal generator according to an exemplary embodiment of the present invention;

FIG. 5 is a detailed circuit diagram of the control signal generator shown in FIG. 4; and

FIG. 6 is a timing chart of the control signal generator shown in FIG. 4.

### DETAILED DESCRIPTION OF THE INVENTION

The present invention will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Now, a driving apparatus for a display device and a display device including the same according to exemplary embodiments of the present invention will be described in more detail with reference to the accompanying drawings, and a liquid crystal display will be described as an example.

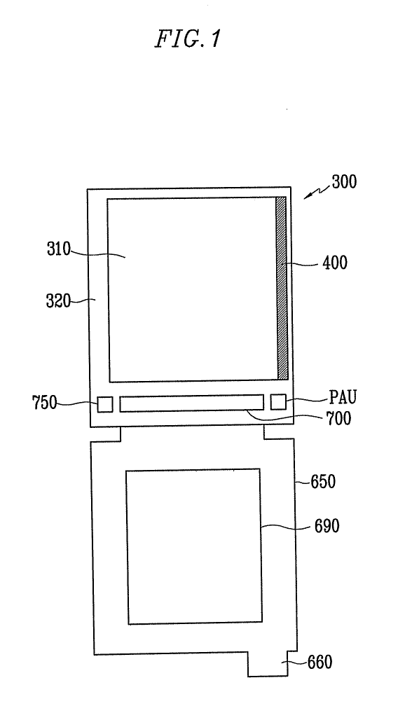

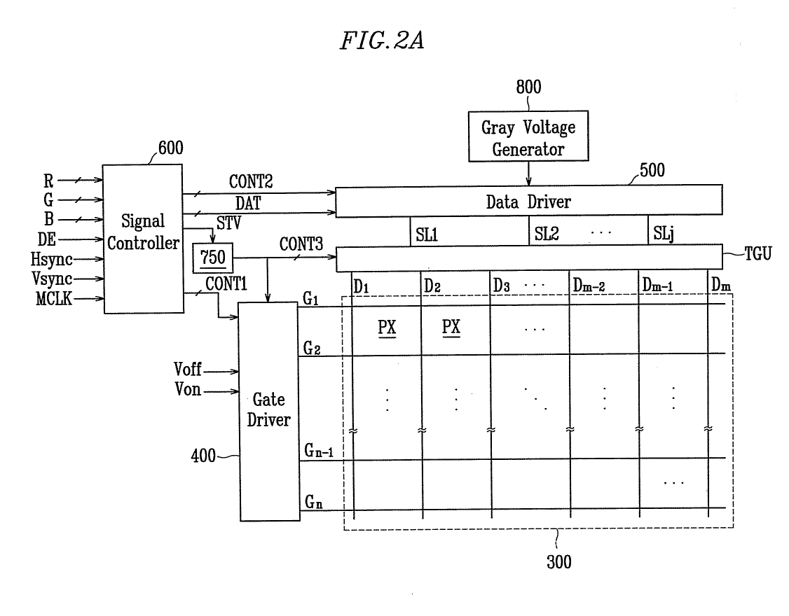

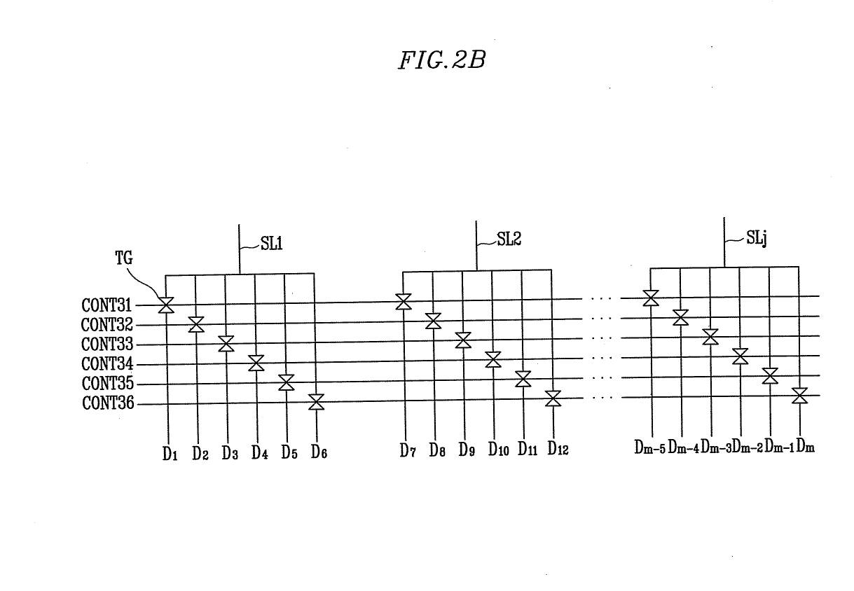

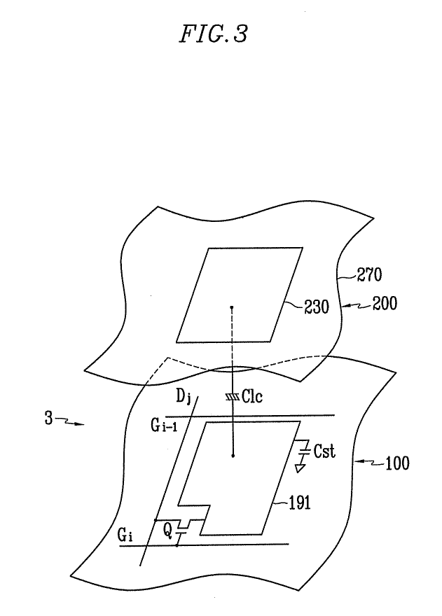

FIG. 1 is a schematic view of a liquid crystal display according to an exemplary embodiment of the present invention. FIG. 2 is a block diagram of a liquid crystal display according to an exemplary embodiment of the present invention. FIG. 3 is an equivalent circuit diagram of one pixel of a liquid crystal display according to an exemplary embodiment of the present invention.

Referring to FIG. 1, the liquid crystal display according to an exemplary embodiment of the present invention includes a display panel 300, a flexible printed circuit (“FPC”) film 650 attached to the display panel 300, and a driving chip 700 and a control signal generator 750 which are both mounted on the display panel 300. Further, a pad unit PAU including a plurality of pads for applying a test signal is disposed at a side of the driving chip 700.

The FPC 650 is attached in the proximity of one base of the display panel 300, and has an opening 690 which exposes some of the display panel 300 when folded. An input section 660 for inputting a signal from the outside is provided at the lower side of the opening 690. A plurality of signal lines (not shown) for electrical connection between the input section 660 and the driving chip 700 and between the driving chip 700 and the display panel 300 are disposed therebetween, and the signal lines form a pad (not shown) having a generally wide width at a point connected to the driving chip 700 and at a point attached to the display panel 300.

The display panel 300 includes a display area 310 for forming a screen and a peripheral area 320, and a light blocking layer (not shown) (e.g., black matrix) for blocking light may be provided in the peripheral area 320. The FPC 650 is attached to the peripheral area 320 of the display panel 300.

As shown in FIG. 2A, the display panel 300 includes a plurality of display signal lines including a plurality of gate lines G₁-Gₙ and a plurality of data lines D₁-Dₘ and a plurality of pixels PX connected thereto and arranged in approximately a matrix form. Most of the pixels PX and the display signal lines G₁-Gₙ and D₁-Dₘ are positioned within the display area 310 (FIG. 1).

Because an upper panel 200 is smaller than a lower panel 100 (FIG. 3), some area of the lower panel 100 is exposed and the data lines D₁-Dₘ extend to the area to be connected to the data driver 500.

The display signal lines G₁-Gₙ and D₁-Dₘ includes a plurality of gate lines G₁-Gₙ that transfer a gate signal (also referred to as a “scanning signal”) and data lines D₁-Dₘ that transfer a data signal. The gate lines G₁-Gₙ extend in approximately a row direction and are substantially parallel to each other, and the data lines D₁-Dₘ extend in approximately a column direction and are substantially parallel to each other, as illustrated in FIG. 2A. The display signal lines G₁-Gₙ and D₁-Dₘ have a generally wide width at points connected to the FPC 650, thereby forming a pad (not shown). The display panel 300 and the FPC 650 are attached to an anisotropically conductive layer (not shown) for electrical connection of the pads.

Referring to FIG. 3, each pixel PX, for example a pixel PX connected to an i-th (i−1, 2, n) gate line Gᵢ and a j-th (j=1, 2, m) data line Dⱼ, includes a switching element Q connected to the signal lines Gᵢ and Dⱼ and a liquid crystal capacitor Clc and a storage capacitor Cst connected to the switching element Q. The storage capacitor Cst may be omitted as needed in alternative exemplary embodiments.

The switching element Q is a three terminal element such as a thin film transistor provided in the lower panel 100. A control terminal of the thin film transistor is connected to the gate line Gᵢ, an input terminal thereof is connected to the data line Dⱼ and an output terminal thereof is connected to the liquid crystal capacitor Clc and the storage capacitor Cst.

The liquid crystal capacitor Clc has a pixel electrode 191 at the lower panel 100 and a common electrode 270 at the upper panel 200 as two terminals of the liquid crystal capacitor Clc, and the liquid crystal layer 3 between two electrodes 191 and 270 functions as a dielectric material. The pixel electrode 191 is connected to the switching element Q, and the common electrode 270 is formed on an entire surface of the upper panel 200 and receives a common voltage Vcom. Unlike a case of FIG. 2, the common electrode 270 may be provided at the lower panel 100, and in this case at least one of two electrodes 191 and 270 may be formed in a line shape or a bar shape.

The storage capacitor Cst as an assistant of the liquid crystal capacitor Clc is formed by overlapping a separate signal line (not shown) and the pixel electrode 191 provided at the lower panel 100 with an insulator interposed therebetween, and a predetermined voltage such as a common voltage Vcom is applied to the separate signal line. However, the storage capacitor Cst may be formed with the overlap of the pixel electrode 191 and a previous gate line directly on the electrode 191 via an insulator.

On the other hand, in order to embody color display, by allowing each pixel PX to inherently display one of the primary colors (spatial division) or to sequentially alternatively display the primary colors (temporal division), a desired color is recognized with the spatial or temporal sum of the primary colors. An example of a set of the primary colors includes red, green and blue colors, but is not limited thereto. FIG. 3 shows as an example of spatial division such that each pixel PX is provided with a color filter 230 for displaying one of the primary colors in a region of the upper panel 200 corresponding to the pixel electrode 191. Unlike the case of FIG. 3, the color filter 230 may be provided under the pixel electrode 191 of the lower panel 100.

At least one polarizer (not shown) for polarizing light is attached to the outer surface of the display panel 300.

The gray voltage generator 800 generates two sets of gray voltages (or reference gray voltage sets) related to transmittance of the pixel PX. One of the two sets has a positive value and the other set has a negative value relative to a common voltage Vcom.

The gate driver 400 is connected to the gate lines G₁-Gₙ of the display panel 300 to apply a gate signal Gout consisting of a combination of a gate-on voltage Von and a gate-off voltage Voff to the gate lines G₁-Gₙ.

The data driver 500 is connected to the data lines D₁-Dₘ of the display panel 300 through a transmission gate TG of a transmission gate unit TGU, selects a gray voltage from the gray voltage generator 800, and applies the gray voltage as a data signal to the data lines D₁-Dₘ. Each of 6 transmission gates TG is connected to signal lines (SL1, SL2, . . . SLj) from the data driver 500, and the transmission gates TG belonging to the same row are connected to each other to receive the same control signal.

The control signal generator 750 is integrated in the display panel 300, generates the control signal CONT3, and applies the signal to the gate driver 400 and the transmission gate unit TGU.

The signal controller 600 controls the gate driver 400, the data driver 500 and so on.

The driving chip 700 receives a signal from the outside through a signal line (not shown) which is provided in the input section 660 of the FPC 650 and supplies the signal to the display panel 300 through wiring provided in the peripheral area 320 of the display panel 300. The driving chip 700 includes the data driver 500, the signal controller 600, and the gray voltage generator 800 shown in FIG. 2A.

Now, a display operation of the liquid crystal display will be described in more detail hereinbelow.

The signal controller 600 receives input image signals R, G and B from an external graphics controller (not shown) and input control signals for controlling the display of the signals. The input control signals include, for example, a vertical synchronization signal Vsync, a horizontal synchronizing signal Hsync, a main clock signal MCLK and a data enable signal DE.

The signal controller 600 appropriately processes input image signals R, G and B to correspond to an operating condition of the display panel 300 based on the input image signals R, G and B and input control signals, generates a gate control signal CONT1 and a data control signal CONT2, then transfers the gate control signal CONT1 to the gate driver 400 and transfers the data control signal CONT2 and the processed image signal DAT to the data driver 500.

The control signal generator 750 generates a control signal CONT3 and transfers the control signal CONT3 to each of the transmission gates TG of the transmission gate unit TGU and the gate driver 400.

The gate control signal CONT1 includes a scanning start signal STV which instructs scanning start and at least one clock signal which controls an output period of a gate-on voltage Von.

The data control signal CONT2 includes a horizontal synchronization start signal STH which informs transfer start of image data to one row (set) of pixels PX and a load signal LOAD and a data clock signal HCLK for applying a data signal to data lines D₁-Dₘ. The data control signal CONT2 may further include an inversion signal RVS for inverting the voltage polarity of a data signal to a common voltage Vcom (hereinafter, “voltage polarity of a data signal to a common voltage” is referred to as “polarity of a data signal”).

The switching control signal CONT3 includes an output enable signal OE which limits a sustain time of a gate-on voltage Von, and switching signals CONT31-CONT36 (FIG. 2B) which control turn-on and turn-off of transmission gates TG.

The data driver 500 receives a digital image signal DAT for one row (set) of pixels PX depending on the data control signal CONT2 from the signal controller 600, and converts the digital image signal DAT to an analog data signal by selecting a gray voltage corresponding to each digital image signal DAT. The converted analog data signal is applied to the corresponding data line D₁-Dₘ through the transmission gates TG that are turned on by switching signals CONT31-CONT36 which are input for a predetermined interval.

The gate driver 400 applies a gate-on voltage Von to gate lines G₁-Gₙ depending on the gate control signal CONT1 from the signal controller 600 and the output enable signal OE from the switching control signal 750 to turn on a switching element Q connected to the gate lines G₁-Gₙ. Then, data signals which are applied to the data lines D₁-Dₘ are applied to the corresponding pixels PX through the switching elements Q that are turned on.

A difference between a voltage of a data signal applied to the pixel PX and a common voltage Vcom is represented by a charge voltage, e.g., a pixel voltage, of the liquid crystal capacitor Clc. Liquid crystal molecules change their arrangement depending on a magnitude of a pixel voltage, so that polarization of light passing through the liquid crystal layer 3 is changed. The change of the polarization is represented with the change in transmittance of light by the polarizer attached to the display panel 300.

By repeating the process with a unit of one horizontal period (referred to as “1H”, the same as one period of a horizontal synchronizing signal Hsync and a data enable signal DE), a gate-on voltage Von is sequentially applied to all gate lines G₁-Gₙ, whereby a data signal is applied to all pixels PX, so that an image of one frame is displayed.

A state of an inversion signal RVS applied to the data driver 500 is controlled so that a next frame starts when one frame ends, and the polarity of a data signal applied to each pixel PX is opposite to the polarity in a previous frame (“frame inversion”). In this case, according to characteristics of the inversion signal RVS, even within one frame, the polarity of a data signal flowing through one data line may be changed (e.g., row inversion and dot inversion) or the polarity of the data signals applied to one pixel row may also be different from each other (e.g., column inversion, dot inversion).

Now, a structure and operation of a control signal generator will be described in more detail hereinbelow with reference to the drawings.

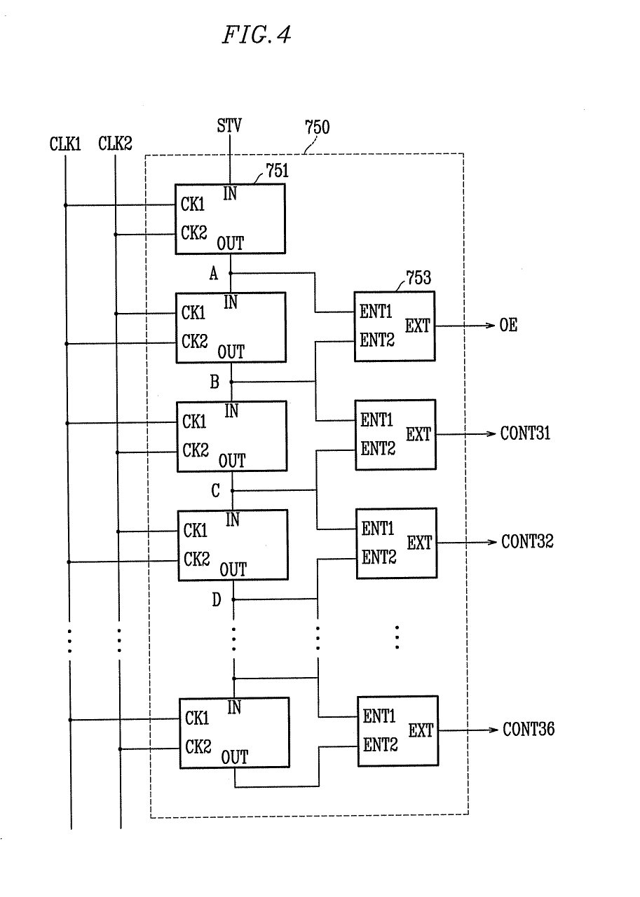

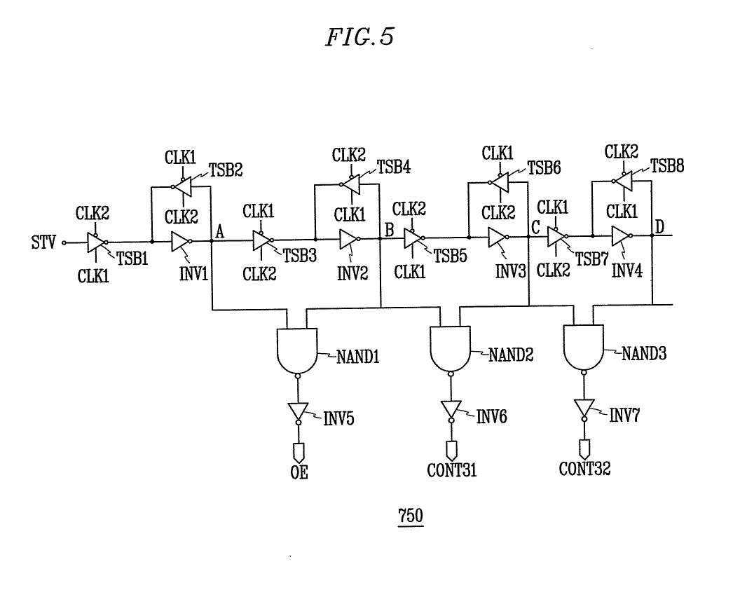

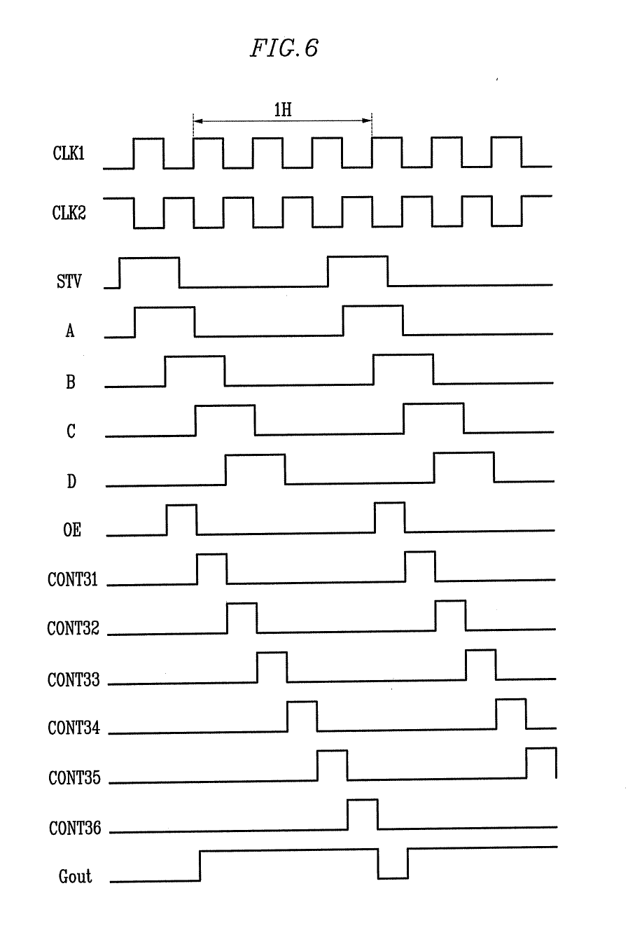

FIG. 4 is a block diagram of a control signal generator according to an exemplary embodiment of the present invention. FIG. 5 is a detailed circuit diagram of the control signal generator shown in FIG. 4 FIG. 6 is a timing chart of the control signal generator shown in FIG. 4

The control signal generator 750 shown in FIG. 4 is a shift register including a plurality of stages 751 arranged in a line and a plurality of logic units 753 which are respectively connected to each of the gate lines G₁-Gₙ, and a scanning start signal STV and a plurality of clock signals CLK1 and CLK2 are input thereto.

The stages 751 and the logic units 753 are formed with the same process as that of the switching elements Q of the pixels PX, and are integrated on the same substrate. In this case, the switching elements Q may be made of low temperature polysilicon.

Each stage 751 has an input terminal IN, an output terminal OUT and clock terminals CK1 and CK2. Each logic unit 753 has input terminals ENT1 and ENT2 and an output terminal EXT.

The output of a previous stage is input to the input terminal IN of each next stage 751, and the clock signals CLK1 and CLK2 are input to the clock terminals CK1 and CK2, respectively, and each output of adjacent stages is input to the input terminals ENT1 and ENT2, respectively, of each logic unit 753.

However, instead of the output of the previous stage, a scanning start signal STV may be input to a first stage 751 of the shift register 750. Further, when the clock signal CLK1 is input to the clock terminal CK1 of any stage 751 and the clock signal CLK2 is input to the clock terminal CK2, the clock signal CLK2 is input to the clock terminal CK1 and the clock signal CLK1 is input to the clock terminal CK2 of vertically adjacent stages.

It is preferable that when a voltage level of each of the clock signals CLK1 and CLK2 is “high”, the voltage is identical to a gate-on voltage Von so as to drive a switching element Q of a pixel PX, and when a voltage level thereof is “low”, the voltage is identical to a gate-off voltage Voff. As shown in FIG. 6, each of the clock signals CLK1 and CLK2 may have a duty ratio of 50%, and a phase difference between two clock signals CLK1 and CLK2 may be 180°.

FIG. 5 shows the first to fourth stages 751 and the first to third logic units 753 of FIG. 4. As shown in FIG. 5, each stage 751 includes a plurality of tri-state buffers and an inverter, and each logic unit 753 includes a NAND circuit and an inverter.

Each stage 751, for example the first stage, includes a plurality of tri-state buffers TSB1 and TSB2 and an inverter INV1.

The inverter INV1 includes an input terminal and an output terminal, and the tri-state buffers TSB1 and TSB2 further include terminals which receives clock signals CLK1 and CLK2 in addition to the input terminal and the output terminal.

The tri-state buffer TSB1 and the inverter INV1 are connected in series to each other and the remaining tri-state buffer TSB2 is connected in parallel to the inverter INV1. As is known, the tri-state buffer TSB2 connected in parallel to the inverter INV1 performs a function of a latch and sustains a previous signal during a predetermined time.

When the clock signal CLK1 becomes “high,” the tri-state buffer TSB1 is turned on to invert and send an input signal, and when the clock signal CLK1 becomes “low,” the tri-state buffer TSB1 is turned off. Further, tri-state buffers TSB4, TSB5 and TSB8 also perform the same operation as that of the tri-state buffer TSB1.

Alternatively, when the clock signal CLK2 becomes “high,” the tri-state buffer TSB2 is turned on to invert and send an input signal, and when the clock signal CLK2 becomes “low,” the tri-state buffer TSB2 is turned off. Further, tri-state buffers TSB3, TSB6 and TSB7 perform the same operation as that of the tri-state buffer TSB2.

Here, “turn-off” means that the output is not generated by being a high impedance state.

The logic unit 753, for example a first logic unit, includes a NAND circuit NAND1 and an inverter INV5 connected thereto, and the output of the first and second stages is input to the NAND circuit NAND1. The NAND circuit NAND1 and the inverter INV5 substantially form an AND circuit.

Now, an operation of the shift register will be described.

First, after a scanning start signal STV changes from “low” to “high,” the clock signal CLK1 becomes “high.”

Accordingly, since the tri-state buffer TSB1 turns on and the tri-state buffers TSB2 and TSB3 turn off, the scanning start signal STV is inverted two times through the tri-state buffer TSB1 and the inverter INV1 to generate a signal at a node A, as shown in FIG. 6.

Next, if the clock signal CLK1 becomes “low” and the clock signal CLK2 becomes “high,” the tri-state buffer TSB1 is turned off and the tri-state buffers TSB2 and TSB3 are turned on. The signal at the node A is still “high” and is input to each of the tri-state buffer TSB2 and the tri-state buffer TSB3. Then, the inverter INV1 and the tri-state buffer TSB2 continuously circulate while forming a closed circuit, and the signal at the node A continuously sustains “high” during a half period of the clock signals CLK1 and CLK2, whereby the characteristics perform a latch function as described above. Further, the signal at the node A is transmitted to a node B to generate a signal at the node B as shown in FIG. 6.

As described above, since the logic unit 753 simultaneously forms an AND circuit, the logic unit 753 generates an output enable signal OE by outputting a high value when the output of two nodes A and B becomes “high.”

Next, if the clock signal CLK1 becomes “high” and the clock signal CLK2 becomes “low,” the tri-state buffer TSB3 is turned off and the tri-state buffers TSB4 and TSB5 are turned on. At this time, because the scanning start signal STV is in a low state, the output at the node A changes to “low.”

The output at the node B still sustains “high” and sustains “high” during a half period of the clock signals CLK1 and CLK2 while forming and circulating a closed circuit as in the above-described node A, thereby entirely outputting “high” during a period of the clock signals CLK1 and CLK2.

By repeating the same operation even in the remaining stages in this manner, as described above, each of the switching signals CONT31-CONT36 which are shifted by a half period of the clock signals CLK1 and CLK2 is generated for 1H rather than the output enable signal OE.

On the other hand, test pads for applying a test signal can be reduced when a VI test is performed by integrating the control signal generator 750 in the display panel 300.

For example, when the VI test is performed, a total of 7 test pads are required in order to apply the output enable signal OE and the switching signals CONT31-CONT36. However, because the control signal generator 750 has already been formed, it is not necessary to apply the output enable signal OE and the switching signals CONT31-CONT36 from the outside and thus the test pad is also not required. However, basic signals, e.g., the scanning start signal STV and the clock signals CLK1 and CLK2 for driving the control signal generator 750 should be input. Even in this case, in the clock signal CLK2, if an inverter to invert the clock signal CLK1 is provided within the control signal generator 750, two test pads are substantially required. Therefore, the number of the test pads can be reduced to a total of 5.

Further, in the related art, the driving chip 700 generates the signals OE and CONT31-CONT36. However, according to an exemplary embodiment of the present invention, because the control signal generator 750 generates the signals instead of the driving chip 700, the number of pins of the driving chip 700 can be decreased, thereby reducing manufacturing cost.

In this way, if the control signal generator 750 is formed with the same process as that of a switching element Q of a pixel PX, the test pads can be reduced when the VI test is performed and the number of pins of the driving chip 700 can be reduced.

While this invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. A driving apparatus for a display device comprising a plurality of pixels, each comprising a switching element, and gate lines and data lines connected to the pixels, the driving apparatus comprising:
a gate driver which generates a gate signal and applies the gate signal to the gate lines;
a data driver which generates a data signal and applies the data signal to the data lines;
a transmission gate connected to each of the data lines;
a signal controller which controls the gate driver and the data driver; and
a control signal generator which generates a plurality of control signals based on a scanning start signal and a plurality of clock signals and applies the control signals to the gate driver and the transmission gate.

2. The driving apparatus of claim 1, wherein the control signals comprise an output enable signal which adjusts a width of a high interval of the gate signal and a switching signal which controls an operation of the transmission gate.

3. The driving apparatus of claim 2, wherein the control signal generator comprises:
a plurality of stages connected to each other and arranged in a line; and
a logic unit connected to an output of at least two different stages.

4. The driving apparatus of claim 3, wherein each stage comprises:
a first tri-state buffer;
an inverter connected to the first tri-state buffer; and
a second tri-state buffer with an input and an output connected to the input and the output of the inverter, respectively.

5. The driving apparatus of claim 4, wherein each logic unit is substantially an AND circuit.

6. The driving apparatus of claim 1, wherein the control signal generator is integrated in the display device.

7. The driving apparatus of claim 1, wherein the switching element is made of low temperature polysilicon.

8. A display device comprising:
a plurality of pixels, each comprising a switching element;
gate lines and data lines connected to the pixels;
a gate driver which generates a gate signal and applies the gate signal to the gate lines;
a data driver which generates a data signal and applies the data signal to the data lines;
a transmission gate connected to each of the data lines;
a signal controller which controls the gate driver and the data driver; and
a control signal generator which generates a plurality of control signals based on a scanning start signal and a plurality of clock signals and applies the control signals to the gate driver and the transmission gate.

9. The display device of claim 8, wherein the control signals comprise an output enable signal which adjusts a width of a high interval of the gate signal and a switching signal which controls an operation of the transmission gate.

10. The display device of claim 9, wherein the control signal generator comprises:
a plurality of stages connected to each other and arranged in a line; and
a logic unit connected to a corresponding output of at least two different stages.

11. The display device of claim 10, wherein each stage comprises:
a first tri-state buffer;
an inverter connected to the first tri-state buffer; and
a second tri-state buffer with an input and an output connected to the input and the output of the inverter, respectively.

12. The display device of claim 11, wherein each logic unit is substantially an AND circuit.

13. The display device of claim 8, wherein the control signal generator is integrated in the display device.

14. The display device of claim 8, wherein the switching element is made of low temperature polysilicon.
